(19) United States
(12) Patent Application Publication
(10) Pub. No.: US 2012/0178394 A1
(43) Pub. Date: Jul. 12, 2012

(54) BROADCAST RECEIVING APPARATUS

(76) Inventors: Atsushi Tominaga, Miyagi-ken (JP); Daisuke Aoyagi, Miyagi-ken (JP)

(21) Appl. No.: 13/345,016

(22) Filed: Jan. 6, 2012

(30) Foreign Application Priority Data
Jan. 7, 2011 (JP) 2011-001804

(51) Int. Cl. H04B 1/16

(52) U.S. Cl. 455/234.1

(57) ABSTRACT

A broadcast receiving apparatus having a seek function of sweeping a received frequency, stopping the sweeping if the level of the received signal is equal to or higher than a threshold level of an S meter signal in SD check (SD check results in H determination), and setting a reception state with the received frequency includes a signal meter configured to detect the level of the received signal, and an AGC circuit configured to control the level of the received signal with the field strength of an input signal. In this case, if the direct current value to be applied to the PIN diode is equal to or higher than a predetermined direct current value, the threshold level of the S meter signal is changed to a lower value under a state where the AGC circuit is operating because a neighboring interfering channel exists.

### CLAIM OF PRIORITY

This application claims benefit of Japanese Patent Application No. 2011-001804 filed on Jan. 7, 2011, which is hereby incorporated by reference in its entirety.

### BACKGROUND

1. Field of the Disclosure

The present disclosure relates to broadcast receiving apparatuses configured to prevent skipping a requested station by mistake during a station selecting operation.

2. Description of the Related Art

A broadcast receiving apparatus is known which includes an automatic channel selecting (seek) function of selecting a high quality channel (such as Japanese Unexamined Patent Application Publication No. 9-294080). The AM radio receiver described in the Unexamined Patent Application Publication No. 9-294080 performs overall judgment on the results of SD (Station Detector) check and IF (Intermediate Frequency) count and selects a high quality channel.

SD check is a determination method which compares an S meter signal indicating the field strength of an intermediate frequency (IF) signal resulting from the frequency conversion of a received RF signal with a threshold level and determines whether the S meter signal is higher (High: H) or lower (Low: L) than the threshold level (hereinafter, called H/L determination). IF count is a determination method which determines the quality of a received frequency. In a state where no inference exists, the count value of an IF signal is an intermediate frequency fIF, which is an average frequency of a frequency spectrum of a target receiving station theoretically. On the other hand, in a state subject to neighboring interference, the count value contains a signal component of a neighboring interfering station. This shifts the frequency spectrum closer to the neighboring interfering station, and the count value N acquired in accordance with the average frequency is also shifted from the fIF. IF count uses this fact.

Generally, in order not to select a low quality channel, the threshold level of an S meter signal in SD check is set to a field strength around 30 [dBuV]. FIG. 5A is a graph illustrating a relationship between the field strengths of a broadcast station (channel) present in a broadcast band to be sought (vertical axis) and channel frequencies (horizontal axis). Referring to the graph, a received channel A present above the straight line X indicating the threshold level of an S meter signal is a high quality channel determined as H by SD check. A received channel B present below the straight line X is a low quality channel determined as L by SD check.

With a broadcast receiving apparatus in the past, neighboring interference may occur when the signal level of a channel (hereinafter, called a neighboring interfering channel) neighboring to a desirable received channel (hereinafter, called a desired channel) is high. In this case, an AGC (Automatic Gain Control) circuit operates to attenuate the signal level of the neighboring interfering channel. However, when the signal level of the neighboring interfering channel is high, the reception level of the desirable channel is attenuated at the same time. With this, the S meter signal of the high quality channel also falls, the skipping by mistake may occur without H determination by SD check.

In other words, as illustrated in FIG. 5B, when an AGC circuit operates for the attenuation on the basis of the presence of an interfering signal C, the field strengths of the originally high quality channel A and low quality channel B fall together, and the S meter signal corresponding to those channels decreases. This causes the high quality channel A present in the region within Y which should be originally determined as H to be determined as L about the threshold level. As a result, the channel A is not selected and is skipped by mistake.

In order to prevent the skipping by mistake, the attenuation in the AGC circuit may be reduced to prevent the decrease of the S meter signal of a high quality channel. However, this measure may not sufficiently reduce the field strength of the neighboring interfering channel. Thus, the radio interference of the neighboring interfering channel may increase, and the reception performance may decrease.

According to another measure for preventing the skipping by mistake, the threshold level in SD check may be reduced. However, this measure may increase the termination by mistake where a low quality channel is determined as H in a state without a neighboring interfering channel.

### SUMMARY

A broadcast receiving apparatus having a seek function of sweeping a received frequency, stopping the sweeping if the level of the received signal is equal to or higher than a first level, and setting a reception state with the received frequency, the apparatus including a signal meter configured to detect the level of the received signal, and an AGC circuit configured to control the level of the received signal with the field strength of an input signal, wherein, if the field strength of the input signal is equal to or higher than a second level, the value of the first level is changed to a lower value under a state where the AGC circuit is operating.

Under a state where an AGC circuit is operating because of the presence of an interfering signal, if the level of the field strength of an input signal to the AGC circuit is equal to or higher than a predetermined second level, the broadcast receiving apparatus allows changing the value of a threshold level of an S meter signal which is a first level to a lower value. Thus, even when the operation of the AGC circuit lowers the field strength of a high quality broadcast channel, the field strength is determined as H by SD check because the value of the threshold level of an S meter signal is changed lower. This may prevent the skipping of the channel By mistake during channel selection.

### BRIEF DESCRIPTION OF THE DRAWINGS

FIG. 1 is a functional block diagram illustrating an essential configuration of a broadcast receiving apparatus according to an embodiment;

FIG. 2 is a graph illustrating a relationship between DC voltage to be applied to a PIN diode and the field strength of a received RF signal in the broadcast receiving apparatus according to the embodiment;

FIG. 3 is a flowchart illustrating a flow of main processing during a seek operation by the broadcast receiving apparatus according to the embodiment;

FIGS. 4A and 4B are graphs illustrating detection results from a seek operation in the broadcast receiving apparatus according to the embodiment; and

FIGS. 5A and 5B are graphs illustrating detection results from a seek operation in a broadcast receiving apparatus according to an example in the past.

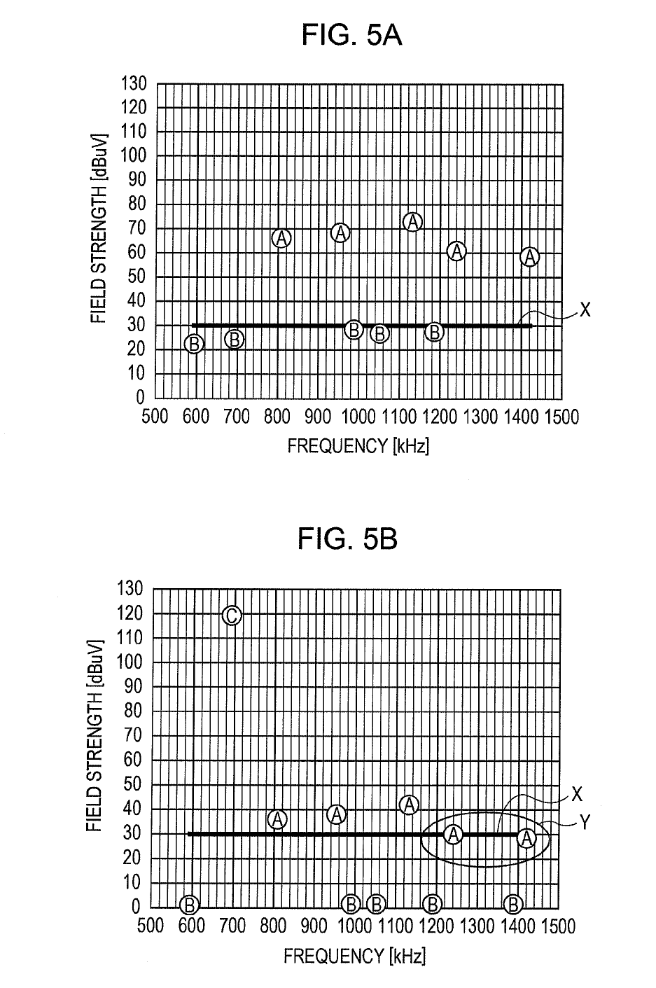

### DESCRIPTION OF THE EXEMPLARY EMBODIMENTS

Embodiments of the present invention will be described in detail below with reference to the attached drawings.

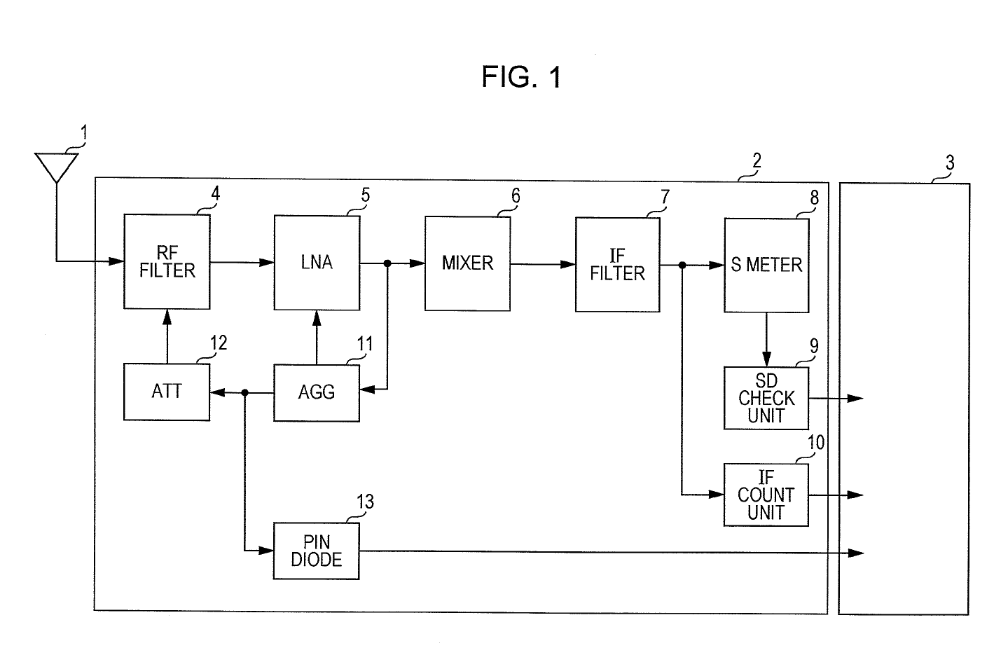

FIG. 1 is a functional block diagram illustrating an essential configuration of a broadcast receiving apparatus according to an embodiment and illustrates an example that the broadcast receiving apparatus is applied to an AM/FM tuner. As illustrated in FIG. 1, the broadcast receiving apparatus receives broadcast waves transmitted from broadcast stations through an antenna 1 and supplies a received RF signal output from the antenna 1 to a tuner unit 2. In the tuner unit 2, a quality check parameter is measured from the received IF signal frequency-converted to an IF signal and is output to a microcomputer unit 3. In the microcomputer unit 3, some determining processes for channel selection are performed on the basis of the result of the parameter measurement.

A channel signal in the broadcast band is extracted from the RF signal output from the antenna 1 in an RF filter 4 and is amplified with low noise in an LNA (Low Noise Amplifier) circuit 5. In a mixer 6, the amplified RF signal is mixed with a locally-generated signal to convert it to an intermediate frequency (IF) signal. Changing the frequency of the locally-generated signal to be supplied to the mixer 6 during a seek operation may allow sweeping the entire broadcast band. In an IF filter 7, the IF signal output from the mixer 6 excluding the received channel signal is limited. In an signal meter (S meter) 8, the IF signal is converted to an S meter signal according to the field strength of the received channel signal.

The channel (broadcast station) selection by the seek function is implemented by using the parameter measured value in the SD check unit 9 and IF count unit 10. SD check and IF count will be described briefly below. SD check is a determination method which compares the level of an S meter signal and a threshold level on firmware of the microcomputer unit 3 to execute H/L determination. In SD check, if the level of an S meter signal is higher (H) than the threshold level, it is determined that a broadcast signal(specific channel) has been captured from a high quality broadcast station. IF count is a determination method which synchronously detects an IF signal and counts the number of times of the excess of the detected value over a predetermined level on firmware of the microcomputer unit 3 to perform H/L determination which determines whether the number exceeds a predetermined value within a predetermined period of time or not. In IF count, if the check results in H determination in which the count is higher than the predetermined value, it is determined that a broadcast signal (specific channel) has been captured from a high quality broadcast station. If the determination results of the two types of method are both H determination, it is determined that a high quality channel has been selected.

The tuner unit 2 includes an AGC circuit 11 configured to detect the signal level of a received RF signal and controls the gain of an LNA circuit 5 on the basis of the DC voltage extracted from the detection output. More specifically, the AGC circuit 11 generates the DC voltage according to the RF level of an input received RF signal and outputs the generated DC voltage to the LNA circuit 5. If an interfering signal (neighboring interfering channel) in an intense electric field is detected during a seek operation, the AGC circuit 11 outputs a control voltage which suppresses the field strength of the interfering signal in response to the high input signal.

An attenuator (ATT) 12 operates to adjust the attenuation of the level of a received RF signal input through the antenna 1 in accordance with the control voltage from the AGC circuit 11 and optimizes the level of the received RF signal input through the antenna 1. The attenuator 12 receives the DC voltage generated by the AGC circuit 11 directly or the DC voltage generated in accordance with it.

The tuner unit 2 includes a PIN diode 13 to which the DC voltage extracted by the AGC circuit 11 is applied. Like the attenuator 12, the PIN diode 13 receives the DC voltage generated by the AGC circuit 11 directly or the DC voltage generated in accordance with it. On the firmware of the microcomputer unit 3, the DC voltage value to be applied to the PIN diode 13 and a threshold level are compared to execute H/L determination. The term, firmware, here refers to software pre-written in a non-volatile storage area of the microcomputer unit 3.

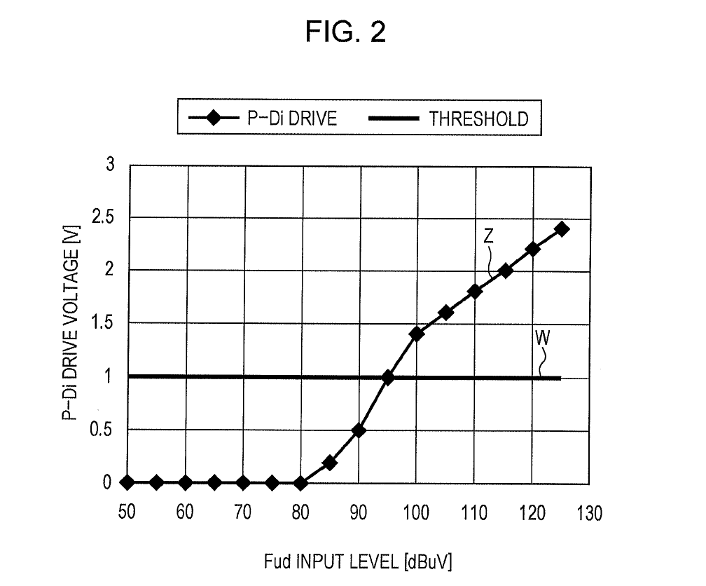

FIG. 2 is a graph illustrating a relationship between DC voltage (vertical axis) to be applied to the PIN diode 13 and the field strength (horizontal axis) of a received RF signal. As illustrated in FIG. 2, the higher the field strength of the received RF signal, the higher the DC voltage to be applied to the PIN diode 13. When the field strength of the received RF signal is 50 to 80 [dBuV], DC voltage is not applied to the PIN diode 13. This is because no interfering signal at or higher than a predetermined level exists and the AGC circuit 11 is not operating.

On the characteristic curve Z of the DC voltage value illustrated in FIG. 2, if the DC voltage value to be applied to the PIN diode 13 exists below the straight line W indicating the threshold level, the H/L determination results in L determination. This state will be called Pin-Di[0] hereinafter. If the DC voltage to be applied to the PIN diode 13 exits above the straight line W indicating the threshold level, the H/L determination results in H determination. This state will be called Pin-Di[1] hereinafter. Though the threshold level is set to 1 [V] in FIG. 2, the threshold level is not limited to the value. The threshold level may be a predetermined DC voltage value.

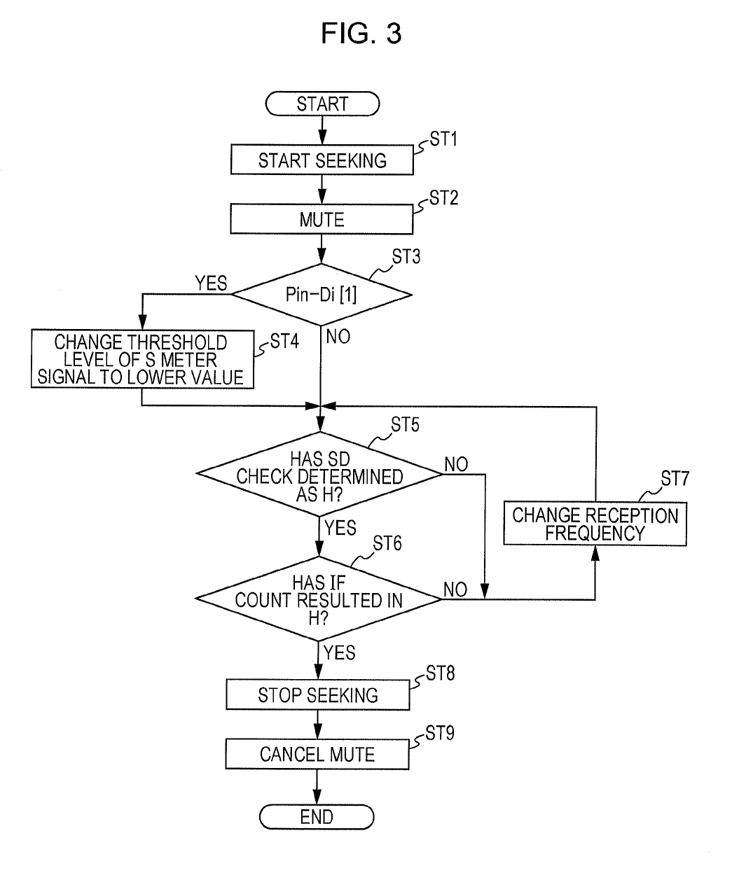

Next, a seek operation in the broadcast receiving apparatus according to this embodiment will be described. FIG. 3 is a flowchart illustrating a flow of main processing during a seek operation by the broadcast receiving apparatus. The seek operation is started in response to the press of an automatic seek button by a user of the broadcast receiving apparatus, for example, in an environment where broadcast waves are receivable (step ST1).

If the seek operation starts, the broadcast receiving apparatus is muted (step ST2), and sweeping the received frequency is started.

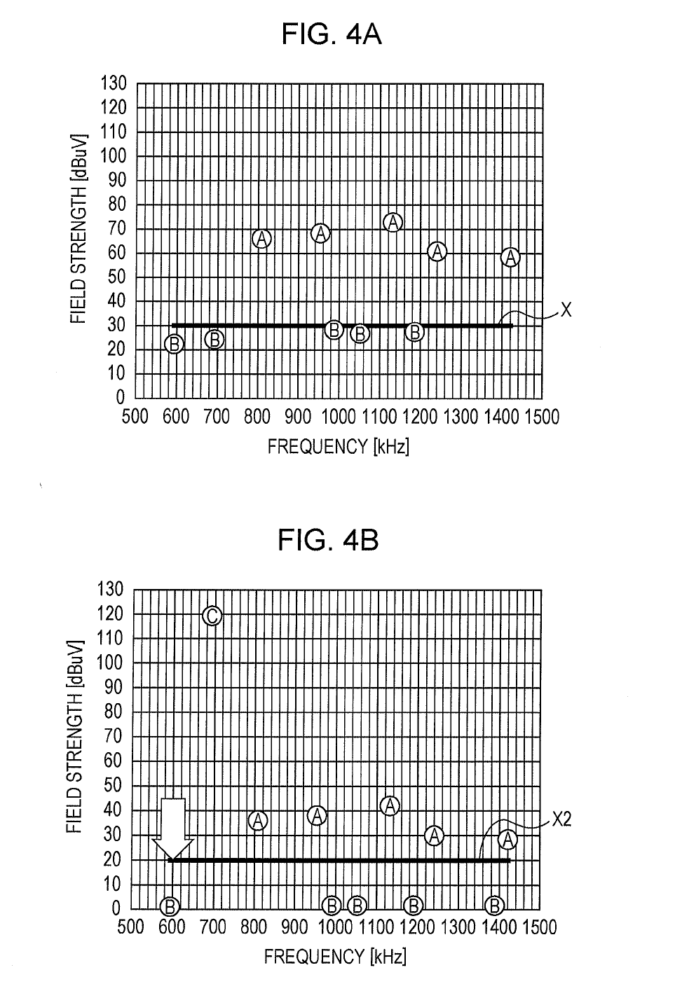

Next, whether the DC voltage to be applied to the PIN diode 13 is equal to or higher than a predetermined DC voltage value or not, that is, it is Pin-Di[1] or not is determined (step ST3). In an environment with an interfering signal, Pin-Di[1] is determined. If Pin-Di[1] is determined (Yes in step ST3), the threshold level of the S meter signal in the SD check unit 9 is changed to a lower value (step ST4), as illustrated in FIG. 4B.

FIGS. 4A and 4B are graphs illustrating a relationship between the field strength of a broadcast station (channel) present in a broadcast band to be sought (vertical axis) and a channel frequencies (horizontal axis). FIG. 4A is a graph illustrating a Pin-Di[0] state in an environment without an interfering signal. The threshold level of the S meter signal in the SD check unit 9 indicated by the straight line X is 30 [dBuV]. On the other hand, FIG. 4B is a graph illustrating a Pin-Di[1] state in an environment with an interfering signal. The threshold level of the S meter signal in the SD check unit 9 indicated by the straight line X2 is changed to 20 [dBuV] that is lower than 30 [dBuV].

Next, whether the H/L determination in SD check results in H determination or not is determined (step ST5). Further, whether the H/L determination in IF count results in H determination or not is determined (step ST6).

If both SD check and IF count do not result in H determination (No in step ST5 and No in step ST6) because a high quality channel is not selected in the current received frequency, the received frequency is changed to a higher frequency or lower frequency (step ST7). The processing returns to step ST5 again, and SD check and IF count are repeated until a high quality channel is selected.

As described above, if Pin-Di[1] is determined in an environment with an interfering signal (Yes in step ST3), the AGC circuit 11 operates to control the gain of the LNA circuit 5 such that the field strength of the interfering signal may be suppressed to a predetermined level or below. This may suppress the received RF signal. Comparing between FIGS. 4A and 4B, the operation by the AGC circuit 11 because of the existence of an interfering channel C reduces the field strengths of the received channels A and B to about 30 [dBuV]. However, as illustrated in FIG. 4B, even when the decrease of the field strength of the high quality channel A further reduces the S meter signal, the high quality channel A still exists above the straight line X2 indicating the threshold level. This is because, the field strength is changed to a lower value than the threshold level of the S meter signal in SD check, which is indicated by the straight line X2 in step ST4. Thus, SD check on the channel A results in H determination, and the skipping by mistake may be avoided.

On the other hand, as illustrated in FIG. 4A, if Pin-Di[0] without an interfering signal is determined (No in step ST3), the threshold level is kept at the value with which no low quality channel is selected. The low quality channel B exists below the straight line X indicating the threshold level. The SD check on the channel B results in L determination, and termination by mistake may be avoided.

If both SD check and IF count result in H determination (Yes in step ST5 and Yes in step ST6) because a high quality channel is selected, the sweeping of the received frequency is stopped, and the seek operation stops (step ST8). Finally, the mute state of the broadcast receiving apparatus is cancelled (step ST9), and the broadcast of the selected broadcast station may be listened and/or viewed.

Under a state where the AGC circuit 11 is operating because of the presence of an interfering signal, if the level of the field strength of an input signal to the AGC circuit 11 is equal to or higher than the threshold level in the PIN diode 13, which is a second level, the broadcast receiving apparatus according to this embodiment allows changing the value of a threshold level of an S meter signal in SD check, which is a first level, to a lower value. Thus, even when the operation of the AGC circuit 11 lowers the field strength of a high quality broadcast channel, the field strength is determined as H by SD check because the value of the threshold level of an S meter signal, which is the first level, is changed lower. This may prevent the skipping of the channel By mistake during channel selection.

The present invention is not limited to the embodiment, and various changes may be made thereto. The present invention is not limited to the size, form and/or the like illustrated in the attached drawings according to the embodiment and may be changed as necessary within the scope where the effects of the present invention may exerted. The present invention may be implemented by changing as necessary without departing from the scope of the object of the present invention.

What is claimed is:

1. A broadcast receiving apparatus having a seek function of sweeping a received frequency, stopping the sweeping if the level of the received signal is equal to or higher than a first level, and setting a reception state with the received frequency, the apparatus comprising:
a signal meter configured to detect the level of the received signal; and
an AGC circuit configured to control the level of the received signal with the field strength of an input signal, wherein, if the field strength of the input signal is equal to or higher than a second level, the value of the first level is changed to a lower value under a state where the AGC circuit is operating.

2. The broadcast receiving apparatus according to claim 1, wherein:
the AGC circuit generates a DC voltage according to the field strength of a received signal and thus controls the level of the received signal; and
the DC voltage generated by the AGC circuit is applied to a PIN diode for detection of the second level, and, if the field strength of the input signal is higher than the second level, the PIN diode is set to turn on.

3. The broadcast receiving apparatus according to claim 1, wherein firmware that is configured to implement the seek function has a determination function configured to determine whether the field strength of the input signal is equal to or higher than the second level.

4. The broadcast receiving apparatus according to claim 1, wherein an AM broadcast is received.

5. The broadcast receiving apparatus according to claim 1, wherein an FM broadcast is received.
